(19) United States
(12) Patent Application Publication
(10) Pub. No.: US 2019/0291252 A1
(43) Pub. Date: Sep. 26, 2019

(54) Reyse Jatzlau Valve Buddy

(71) Applicant: Reyse Wayne Jatzlau, Dime Box, TX (US)

(72) Inventor: Reyse Wayne Jatzlau, Dime Box, TX (US)

(21) Appl. No.: 16/355,809

(22) Filed: Mar. 17, 2019

Related U.S. Application Data
(63) Continuation-in-part of application No. 62/645,510, filed on Mar. 20, 2018.

(51) Int. Cl. B25B 27/24; B66F 11/00

(52) U.S. Cl. CPC B25B 27/24; B66F 11/00

(57) ABSTRACT

This invention (called the VALVE BUDDY) is a compact mechanical tool with attachments that aids in the manipulation of heavy and/or ungainly valves, hereafter called the Working Load. The VALVE BUDDY allows operators to safely lift, elevate, move or position a Working Load with or without bodily handling the Working Load thus improving safety and work efficiency.

### BACKGROUND

Example Areas of application are, but not limited to: oil production and its supporting industries and facilities (both on-shore and off-shore), the air conditioning/refrigeration industry (including residential, industrial, commercial, manufacturing, installation and maintenance sections), the water handling and processing sectors (including fresh, reclaimed, sewer treatment and delivery facilities for Industrial, Commercial, Residential and Municipal processing, plant installation, maintenance and modification) and many manufacturing endeavors. In all of these there is a need for tools that allow safe and convenient manual and mechanical handling of valves weighing over 50 pounds. Examples of such handling actions: transportation from/to a field service vehicle during installation, service, repair and replacement, lifting, lowering, moving, positioning, raising and holding of valves (hereafter called the Working Load) from, down to, on, above or below local floor/ground level and from vehicles such as carts, truck beds, dollies, lifts, pallets, cranes etc. The Reyse Jatzlau VALVE BUDDY base plane is local floor/ground level. The operating zone of the VALVE BUDDY includes but is not limited to that volume which human operators would generate/require if two to four Operators were to attach a VALVE BUDDY to the Working Load and manually perform the lifting, lowering, moving, positioning, raising, transporting, adjusting and holding of the Working Load. The normal maximum manual lift of the Working Load using the VALVE BUDDY is five feet above local floor/ground level. The nominal maximum operating lift weight capacity for the VALVE BUDDY depends upon the Model of the VALVE BUDDY being used and usually runs from approximately 50 pounds to 300 pounds.

The above noted operations on Working Loads have been and are currently manually performed by humans with limited to no mechanical aid or mechanical advantage outside of make-shift leverage (the most common aid) or by utilizing large sized externally powered mobile pieces of equipment such as fork lifts, truck mounted gib cranes or motorized cranes attached to the Working Load with chains, ropes or cables. Use of the VALVE BUDDY for the manual (or by utilizing powered mobile pieces of equipment such as fork lifts, truck mounted gib cranes or motorized cranes) lifting, positioning, re-setting, holding, capturing, lowering and setting down of the Working Load provides the humans with much less exposure body injury (such as instantaneous or repetitive physical stress overload, strikes to body parts, or positional injury). The VALVE BUDDY fully secures the Working Load preventing uncontrolled slippage generated by the shape, weight, size and ungainliness of the Working Load.

In general, when the Working Load manipulation is outdoors or within a large facility the workers may be able to utilize available powered lifting and moving equipment. When the manipulation is indoors or within an installation where there is limited maneuvering space or there are no powered devices available, or, when there is no physical space or access for the powered lifting equipment, the usual mechanical aides for manipulating the Working Loads are pry bars, two wheeled dollies, limited height roll-about engine lifts or other makeshift devices generated from locally available tools and materials. The pry bars and makeshift devices generally do not prevent Working Load dropping or unintentional roll-off or slipping of the Working Load, nor do they provide a stress-free grip in any dimension. Nor do they generally provide sufficient mechanical advantage to prevent over stressing of the operator's muscles, fingers, hands, arms, shoulders or backs.

### SUMMARY OF THE INVENTION

This Kit invention, hereafter called the VALVE BUDDY, is a series of specialized compact mechanical devices with attachments as needed (See the Figures List). The VALVE BUDDY is a manual (or can utilize some powered mobile pieces of equipment such as fork lifts, truck mounted gib cranes or motorized cranes) Working Load handling tool for lifting, lowering, moving, positioning, raising, transporting, setting, re-setting, capturing, replacing, setting down of valves (hereafter called the Working Load) from down to, on, above or below local floor/ground level to safely manually handle the Working Load from at or near the local ground/floor. The invention's primary component materials are steel, aluminum or other metals, non-metallic composites or a combination of the noted materials. The fabrication and or assembly of the components and assemblies are by welding, casting, stamping, bolting, pinning, riveting, printing or a combination of these noted methods.

### DESCRIPTION OF THE FIGURES/DRAWINGS

FIG. 1. FIG. 1 is a view with a Model 150# VALVE BUDDY attached to a customer's Valve Adapter in the manner that the VALVE BUDDY would be used in the field.

FIG. 2. FIG. 2 shows the VALVE BUDDY component identification numbers for a pinned Square Type Manual Lifting Handle unit.

FIG. 3. FIG. 3 is a Plan View of a VALVE BUDDY with a two or four Operator Square Type Manual Lifting Handle in position for a manual Working Load maneuver.

FIG. 4. FIG. 4 shows the VALVE BUDDY component identification numbers for a Quick Attach and Release Round TEE Type Manual Lifting Handle in position for a manual Working Load maneuver.

FIG. 5. FIG. 5 shows a VALVE BUDDY with a built-on Ring Handle.

FIG. 6. FIG. 6 shows a VALVE BUDDY'S Standard TEE Handle details.

FIG. 7. FIG. 7 describes a VALVE BUDDY that has the ability to be adjusted in the field by varying the Spur diameter positions to accommodate nonstandard Valve Handle Adaptors.

### DETAILED DESCRIPTIONS OF THE VALVE BUDDY DEVICES

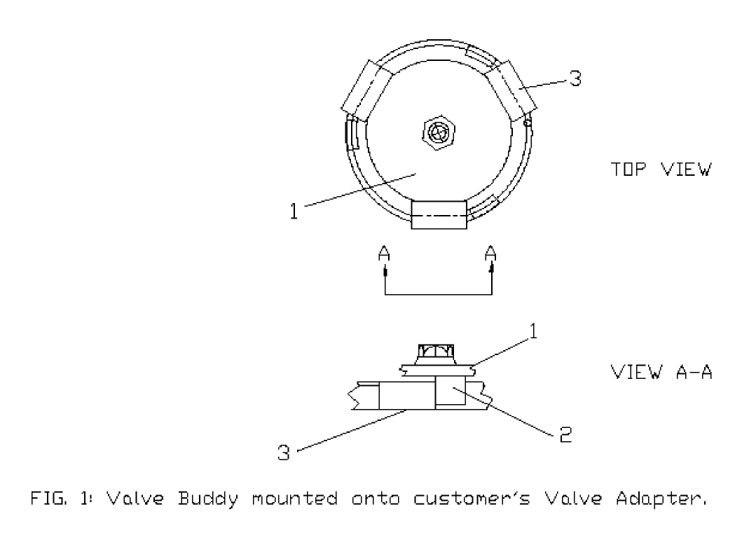

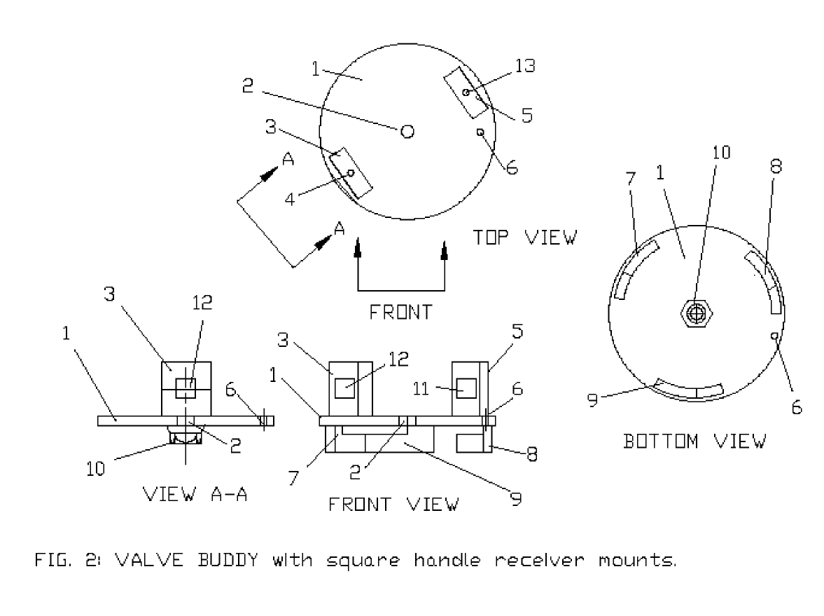

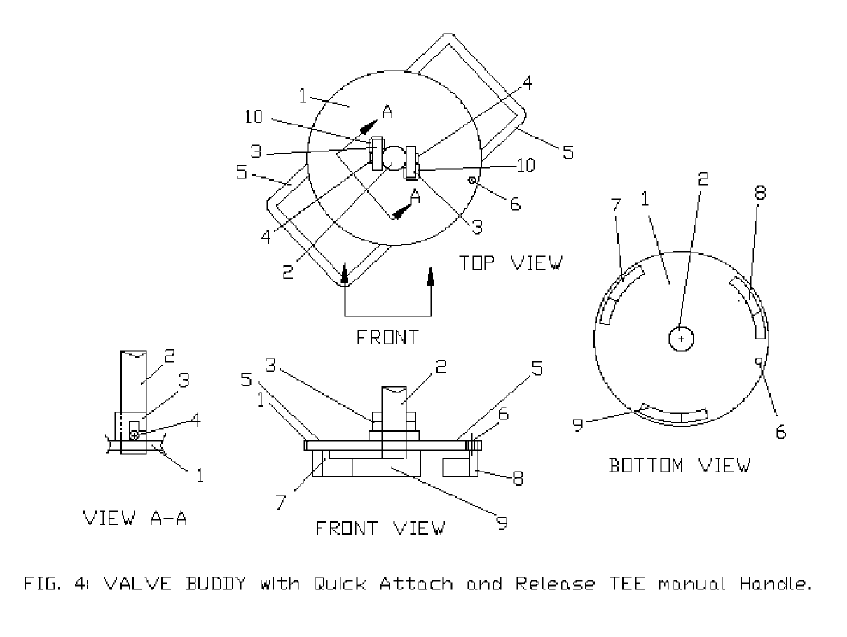

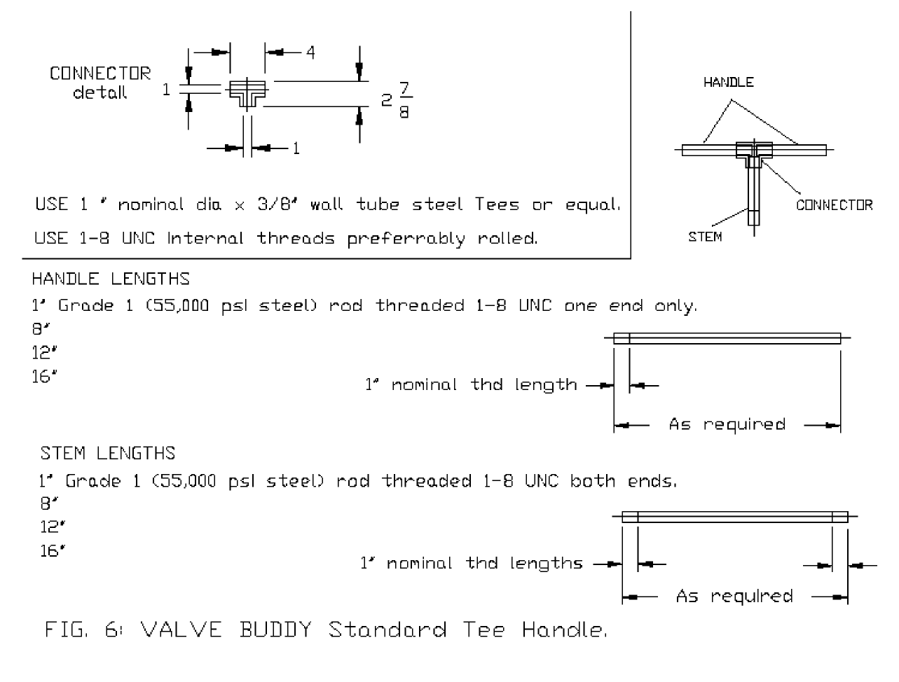

In FIG. 1, the VALVE BUDDY is seen to be a specialized, compact tool with a Top Plate 1, approximately 7″ in diameter, and an overall height of approximately 4″ when the three Spurs 2 are inserted into the Customer's Valve Adapter Tubes 3. Once a VALVE BUDDY is installed on the Customer's Valve Adapter, a steel ¼″ pin is inserted into FIG. 2's Locking Port 6 to prevent the VAVE BUDDY from backing the Spurs 7, 8 and 9 out of the Customer's Valve Adapter, With a Manual Operator Handle such as FIG. 2 and FIG. 4 the overall length is approximately 36″, the width about 8″ and the weight is about 22#. For a Manual Tee Type Operator Handle such as FIG. 4 the overall length is approximately 36″ (see FIG. 6), the width is about 11″ and the weight is about 19#.

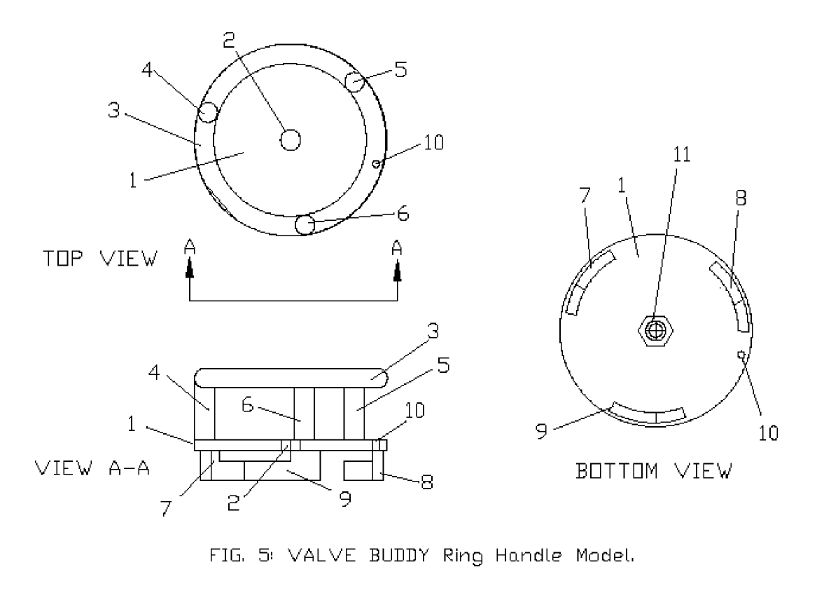

The VALVE BUDDY has two Tee Handle mounting options and two horizontal Handle options. The first one is the Standard Tee Handle Threaded Receiver option of FIG. 2 component 10 and Handles of FIG. 6. The second option is a VALVE BUDDY with a Quick Attach and Release TEE handle (see FIG. 4 component 2). This Model, FIG. 4, combines some of the attributes of the Models of FIG. 2 and FIG. 5. The VALVE BUDDY Quick Attach and Release TEE Handle Model, FIG. 4, utilizes the same mounting options to the Customer's Valve Adapter as does the Standard Models namely: the Base Plate 1; a steel safety pin in Port 6 to prevent the VAVE BUDDY from backing the Spurs 7, 8 and 9 out of the Customer's Valve Adapter; and an Extension Shaft 2 that has a locking mechanism: in FIG. 2 the thread friction locks the Tee Handle to Plate 1, where as in FIG. 5, the Locking Pin 4 is pressed into the Extension Shaft 2, which engages the notches in Locking Catches 3. The position of Pin 4 is a through hole near the Extension Shaft's insertion end at Plate 1. The Extension Shaft is received by an Alignment Port in Plate 1 and by Locking Guides 3. Locking Guides 3 have “L” shaped slots to capture the ends of Locking Pin 4. Locking Guides 3 are mounted to Plate 1 via Welds 10 and transfer the tensile loading from Extension Shaft 2 through Plate 1 to the Spurs 7, 8 and 9 when the Working Load is lifted. The Quick Attach and Release TEE handle unit has two Handles 5 for carrying the loaded VALVE BUDDY. The tallest configuration is approximately 20″. The greatest Tee Handle width is about 36″ (the total weight excluding the “U” shaped Handles 5) is approximately 9#.

The maximum manual Working Load Capacity for a VALVE BUDDY is the one that utilizes square Handle rods, FIG. 2. In general, the Standard VALVE BUDDY consists of a Base Plate 1, that is ⅜″ thick with a 1 1/16″ diameter Tee Handle Alignment Port 2, drilled through its center. For Base Plate 1, its dimensions and strength are determined by the requirements of the maximum Working Load it is expected to handle. For example, a Standard Model 150# VALVE BUDDY has a maximum allowable Working Load of 150# total (valve plus VALVE BUDDY weight) yielding a minimum VALVE BUDDY component safety factor of 4. The Tee Handle Receiver 10 is a 3/4-10 UNC nut centered over the 1-16″ diameter center port in Plate 1 and welded onto the underside (valve side) of Plate 1 and takes the tensile stresses of the Working Load, acts as a stop for Tee Handle tightening and can be field replaced if the threads are damaged.

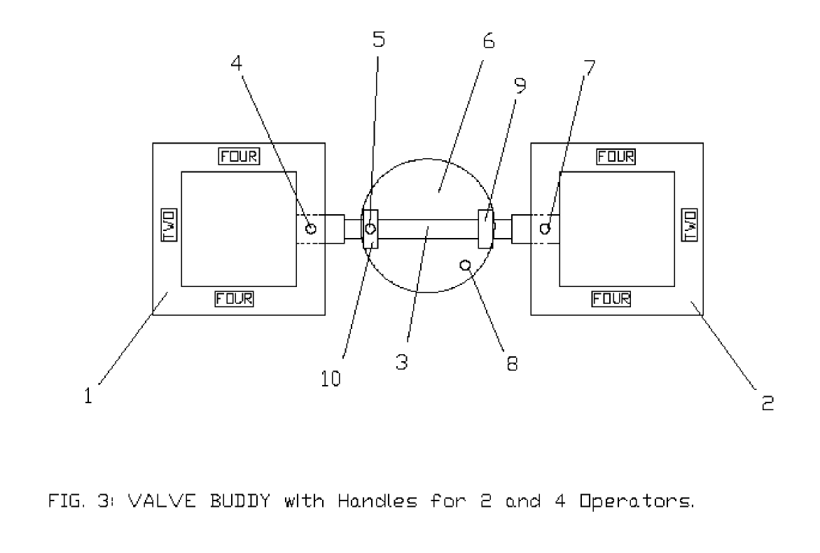

The Standard VALVE BUDDY, FIG. 2, uses a pair of Square Manual Lifting Handle Ports 3 and 5 as mounting points for the Square Handles of FIG. 3 and as lifting points when maneuvering Working Loads that are greater than 150# with powered lifts. Pin 4 and Pin 11 hold the Square Manual Lifting Handle in place. When using a Tee Type Manual Lifting Handle, FIG. 6, the Working Load maneuvering can be near the floor or ground level utilizing from one to four Operators, thus reducing the chance of leg, ankle, foot and toe injury in case of load slippage or an emergency set down when the Working Load does not exceed the design loads recommended by the manufacturer. Also, arm and back overloading are reduced when the Working Load shared by multiple Operators and is not lifted above knee level. When the Working Load needs to be at or above the waist level, the use of a Square Manual Lifting Handle, FIG. 3, or a Round Ring Handled VALVE BUDDY model, FIG. 5 is preferred,

The FIG. 4 configuration provides exceptional safety for the Operators by allowing as many as 2 Operators to work at or near the VALVE BUDDY.

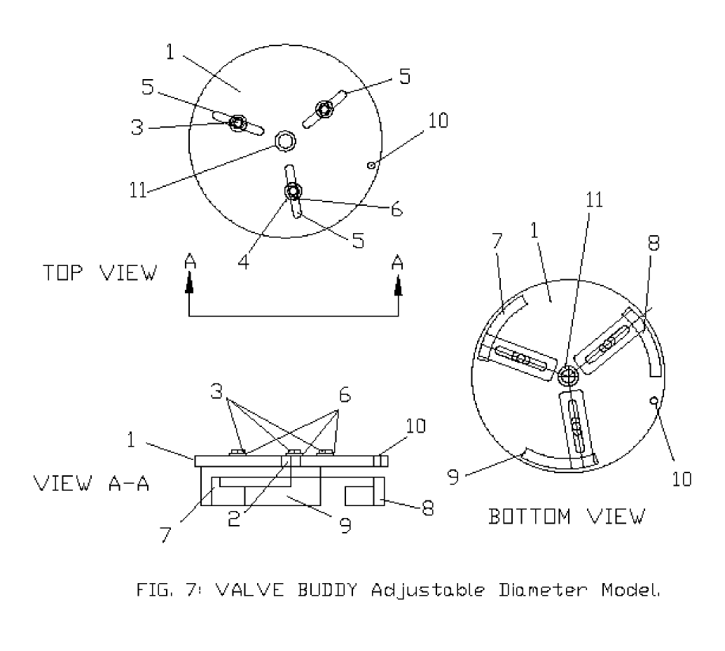

There is more than one manufacturer of Valve Handle Adapters used in the field and the dimensions may be different. The FIG. 7 Adjustable VALVE BUDDY Model provides limited adjustability for such an occurrence. The Base Plate 1 has three Slots 5 that receive the Bosses 4 of Spurs 7, 8 and 9. The Spurs are independently adjustable, and each is secured in place by tightening the Bolts 3. The Washers 6 distributes the clamping loads such that the Spurs 7, 8 and 9 do not come loose during use. Port 2 receives the threaded end of a Standard Tee Handle, FIG. 6, which is retained by the Handle Nut 11. After the Adjustable VALVE BUDDY Model is fitted onto the Valve Handle Adapter, a securing pin is inserted into Lock Hole 10.

1. The Valve Buddy System is a kit of unitary tools that allow an Operator to securely and safely attach a Valve Buddy to a single valve or a set of valves, hereafter called the Working Load, that is to be moved, installed, repaired, adjusted or otherwise be maneuvered without using ropes, cables, chains, cable ties, adhesives, welding, or other types or kinds of attachments that are not part of a Valve Buddy. The Valve Buddy with the attached Working Load is then safely and securely moved by hand, or with a fork lift or other equipment utilizing attachment devices that are part of or attached to the chosen Valve Buddy (see the individual Figures/Drawings).
